(19) United States
(12) Patent Application Publication
(10) Pub. No.: US 2022/0007694 A1
(43) Pub. Date: Jan. 13, 2022

(54) METHOD FOR PRODUCING COOKED RICE FOOD

(71) Applicant: NICHIREI FOODS INC., Tokyo-to (JP)

(72) Inventors: Akiko SAWADA, Chiba-shi (JP); Masao SAWADA, Chiba-shi (JP)

(73) Assignee: NICHIREI FOODS INC., Tokyo-to (JP)

(21) Appl. No.: 17/486,151

(22) Filed: Sep. 27, 2021

Related U.S. Application Data
(63) Continuation of application No. PCT/JP2020/013973, filed on Mar. 27, 2020.

(30) Foreign Application Priority Data
Mar. 28, 2019 (JP) 2019-064508

(51) Int. Cl. A23L 7/196; A23L 5/10; A23B 9/10

(52) U.S. Cl. CPC A23L 7/1963; A23L 5/13; A23V 2002/00; A23B 9/10; A23L 7/1965

(57) ABSTRACT

Disclosed is a method for producing a cooked rice food, comprising (a) a heating step of boiling or steaming raw material rice, and (b) a dextrin solution contacting step of contacting the rice with a dextrin solution at least during or after the heating step, wherein the dextrin solution comprises dextrin having a dextrose equivalent of 2 to 15. According to this production method, a cooked rice food having the same quality as rice cooked by a usual method can be produced with a high yield.

### CROSS REFERENCE TO RELATED APPLICATIONS

The present patent application claims priority based on Japanese Patent Application No. 2019-64508 filed on Mar. 28, 2019, and the whole disclosures of the earlier patent applications are hereby incorporated by reference as a part of this description.

### TECHNICAL FIELD

The present invention relates to a method for producing a cooked rice food.

### BACKGROUND ART

Rice is a staple food in many countries around the world, such as Japan. In addition, rice is usually eaten after heat cooking raw material rice, such as boiling or steaming. Generally, when rice is cooked, the raw material rice is washed, put into a rice cooker or the like, with the addition of water at 1.0 to 1.2 times as much as the raw material rice, and heated while being immersed in water. On the other hand, when rice is steamed, the raw material rice is immersed in water, then drained, put in a steamer, such as a steaming basket, and heated by boiling water (steam). The texture of cooked rice may vary depending on preference of the eater, presence or absence of further processing, and the like.

By the way, when a large amount of cooked rice food is continuously produced, the amount of water added to raw rice as raw material (ratio of added water) greatly influences the quality, such as texture, of cooked rice food product. A low ratio of added water gives a firm texture of the rice grains in the cooked rice food but too low a ratio of added water leaves unboiled portion and results in a hard texture. On the other hand, high ratio of added water gives a soft texture of the rice grains of the cooked rice food, but too high a ratio of added water makes the texture too soft and results in a sticky texture.

So far, various proposals have been made for the production of cooked rice foods to improve the yield (yield rate) of the cooked rice food product with respect to the mass of raw material rice as a raw material (for example, Patent Documents 1 to 3). However, the conventional method impairs texture of the cooked rice food obtained and increases viscosity to generate sticky viscosity (stickiness), which is far from obtaining cooked rice foods with a preferred quality.

Further, there is disclosed a method for improving the yield of cooked rice foods obtained by adding a starch decomposition product in combination with oligosaccharide and/or reduced maltose when the rice is immersed in water before cooking (for example, Patent Document 4). Further, there is disclosed a method for improving texture and flavor of cooked rice foods obtained by contacting the cooked rice foods after cooking with a treatment liquid comprising saccharide (for example, Patent Document 5). However, the cooked rice foods obtained by these methods are far from having a preferred quality in terms of hardness and stickiness.

Under the above situation, there is still demanded a method for high-yield production of cooked rice foods with the same quality as rice cooked by a usual method.

### CITATION LIST

### Patent Document

### [Patent Document 1] Japanese Patent Laid-Open No. 2016-167999

### [Patent Document 2] Japanese Patent Laid-Open No. 2017-143771

### [Patent Document 3] Japanese Patent Laid-Open No. 2006-14617

### [Patent Document 4] Japanese Patent Laid-Open No. 2004-201617

### [Patent Document 5] Japanese Patent Laid-Open No. 2012-24056

### SUMMARY OF INVENTION

The present inventors have found that in the process of producing a cooked rice food, a cooked rice food with the same quality as rice cooked by a usual method can be produced with a high yield by contacting the rice with a dextrin solution comprising dextrin having a specific range of dextrose equivalent (DE) at a specific timing. The present invention is based on this finding.

Therefore, an object of the present invention is to provide a method for producing a cooked rice food, and specifically a method for producing with a high yield a cooked rice food with the same quality as rice cooked by a usual method.

According to the present invention, the following inventions are provided.

(1) A method for producing a cooked rice food comprising the following steps:

(a) a heating step of boiling or steaming raw material rice, and

(b) a dextrin solution contacting step of contacting the rice with a dextrin solution at least during or after the heating step,

wherein the dextrin solution comprises dextrin at a dextrose equivalent of 2 to 15.

(2) The production method according to (1), wherein the rice is contacted with the dextrin solution in the step (b), so that the dextrin solution comprises 0.2 to 2.6% by mass of dextrin based on the total mass of the raw material rice.
(3) The production method according to (1) or (2), wherein the dextrin solution in an amount of 1 to 19% by mass based on the total mass of the rice during or after the heating step is contacted with the rice in the step (b).
(4) The production method according to any one of (1) to (3), wherein the dextrin solution is an aqueous dextrin solution, and the aqueous dextrin solution has a dextrin concentration of 2 to 14% by mass.
(5) The production method according to any one of (1) to (4), wherein the dextrin solution is contacted with the rice after the heating step in the step (b).
(6) The production method according to any one of (1) to (5), wherein the rice in the step (b) has a temperature of 30 to 100° C.
(7) The production method according to any one of (1) to (6), further comprising a freezing step of freezing a cooked rice food obtained.
(8) A method for improving a yield of a cooked rice food comprising the following steps:

(a) a heating step of boiling or steaming raw material rice, and

(b) a dextrin solution contacting step of contacting the rice with a dextrin solution at least during or after the heating step,

wherein the dextrin solution comprises dextrin at a dextrose equivalent of 2 to 15.

(9) A cooked rice food comprising non-glutinous rice and dextrin, wherein

at least a part of the surface of the rice is coated with the dextrin,

the dextrin comprises dextrin with a dextrose equivalent of 2 to 15, and

a yield is 226 to 240%.

According to the present invention, there can be produced with a high yield a cooked rice food having the same quality as rice cooked by a usual method, specifically, the same hardness and stickiness.

### DETAILED DESCRIPTION OF THE INVENTION

In the present specification, the term “cooked rice” refers to a heat cooked rice, such as boiled rice and steamed rice.

In the present specification, “cooked rice food” refers to a food using cooked rice as a main ingredient. Examples of the cooked rice food include white rice, fried rice, pilaf, dry curry, chicken rice, butter rice, bibimbap, jambalaya, nasi goreng, takikomi gohan, sushi rice, chirashi-zushi, rice gruel, porridge, ochazuke, rice ball, and rice burger.

In the present specification, the term “viscosity” and “stickiness” of a cooked rice food is a degree of stickiness of the cooked rice food felt during cooking and eating. For example, a cooked rice food with a high degree of viscosity and stickiness imparts a strong feeling of stickiness (gooeyness) during cooking and eating. On the other hand, a cooked rice food with a low degree of viscosity and stickiness imparts a weak feeling of stickiness (gooeyness) and a strong non-sticky feeling during cooking and eating.

### Production Method of Cooked Rice Food

The method for producing a cooked rice food of the present invention includes (a) a step of heat cooking rice (raw material rice) as a raw material (heating step), and (b) a step of contacting the rice with a dextrin solution comprising dextrin having a dextrose equivalent (DE) in a given range (dextrin solution contacting step) at least during or after the heating step. According to the production method of the present invention, there can be produced with a high yield a cooked rice food having the same quality as rice cooked by a usual method, specifically, the same hardness and stickiness.

In the production method of the present invention, the yield of a cooked rice food can be improved by appropriately setting the following conditions, such as variety of raw material rice, presence or absence of milling, degree of polishing, amount of water (ratio of added water) in the heating step, timing of dextrin contact in the dextrin solution contacting step, amount of dextrin for contact, dextrin concentration in dextrin solution. The yield of cooked rice food is not particularly limited, and is, for example, 226 to 240%, preferably 226 to 236%, and more preferably 228 to 236%. These yield ranges are particularly preferred for cooked rice food using non-glutinous rice (uruchi species rice).

In the production method of the present invention, rice as raw material (raw material rice) refers to rice after threshing or removing rice husks, and before being immersed in water. The raw material rice is not particularly limited as long as it is used as a raw material for cooked rice food, and variety of rice, presence or absence of milling, degree of polishing, and the like can be appropriately selected depending on the desired type of cooked rice food. There can be used rice varieties, such as Japonica rice and Indica rice, and either non-glutinous rice or glutinous rice. Further, there can be used any of the followings: rice before milling (so-called brown rice), rice with germs left (so-called germ rice), and rice after milling (so-called white rice). Further, the raw material rice may be mixed with grains other than rice as long as the effect of the present invention is not impaired. Examples of grains other than rice include wheat, barley (such as rolled barley, barley rice grain, glutinous barley, etc.), adlay (hatomugi), foxtail millet, Japanese millet, millet, black sesame, and white sesame.

The raw material rice is subjected to pretreatment, such as washing and immersing, as necessary, before the heating step. For example, raw material rice is washed with water, immersed in water for 1 hour or more, drained, and then subjected to a heating step.

In the heating step, the raw material rice is subjected to heat cooking, such as boiling and steaming. In the heating step, the raw material rice is boiled by heating the rice immersed in water. The amount of water (ratio of added water) for immersing the rice and the immersion time can be appropriately set depending on the variety of rice, presence or absence of milling, and the like. The mass of water, as a ratio of added water based on the mass of rice, is preferably 1 to 1.5 times, more preferably 1.05 to 1.4 times, and even more preferably 1.05 to 1.35 times. In addition, seasonings and the like may be appropriately added to the water in which the rice is immersed, depending on the desired type of cooked rice food. The water content of rice after being immersed in water varies depending on the variety of rice, immersing conditions, and the like, and is about 30% by mass.

The device for boiling rice is not particularly limited as long as the effect of the present invention is attained, and a well-known rice cooking device for either industrial use or home use can be used. Examples of home-use rice cookers include microprocessor-based rice cookers, IH-type rice cookers, IH-type pressurized rice cookers, gas-type rice cookers, pressure cookers, earthenware pots, and specifically, IH-type rice cooker NP-VN18 manufactured by Zojirushi Corporation.

In the heating step, in the case where the raw material rice is steamed, the rice is immersed in water, drained, and then heated with boiling water (steam). The amount of water (ratio of added water) for immersing the rice and the immersion time can be appropriately set depending on the variety of rice, presence or absence of milling, and the like, and for example, the same conditions as in boiling rice can be used. The device for steaming rice is not particularly limited as long as the effect of the present invention is attained, and a well-known rice steamer for either industrial use or home use can be used. Examples of home-use rice steamers include steamer, such as steaming basket.

The water content of the rice (cooked rice) after the heating step is not particularly limited as long as the effect of the present invention is attained, and can be appropriately set depending on the variety of raw material rice, the desired type of cooked rice food, and the like. Specifically, the water content of the rice after the heating step is preferably 55 to 65% by mass, more preferably 56 to 63% by mass, and even more preferably 58 to 61% by mass. The water content of rice can be measured by a well-known method.

In the dextrin solution contacting step, the rice is contacted with a dextrin solution comprising dextrin having a dextrose equivalent (DE) in a given range, at least during or after the heating step.

In the dextrin solution contacting step, the dextrin solution to be contacted with the rice can be prepared and used by dissolving dextrin in a liquid component acceptable for food hygiene.

The liquid that is acceptable for food hygiene is not particularly limited as long as the effect of the present invention is attained, and water is preferably used from the viewpoint of production cost and influence on the flavor of the cooked rice food produced.

In the production method of the present invention, the dextrin solution comprises one or more types of dextrin each having a specific dextrose equivalent (DE). Dextrin is a general term for low molecular weight carbohydrates obtained by hydrolysis of starch or glycogen, and in the production method of the present invention, either natural dextrin or artificially synthesized dextrin can be used. As a raw material for dextrin, various kinds of starch can be used, and examples thereof include corn starch, such as waxy corn starch, potato starch, sweet potato starch, and tapioca starch. The dextrin comprises in the dextrin solution has DE of 2 to 15, preferably 2 to 12, more preferably 2 to 9, and most preferably 2 to 5. Examples of dextrin made from corn starch include Pinedex #1 (DE7-9), Pinedex #100 (DE2-5 (average DE4)), and Pinedex #2 (DE10-12) manufactured by Matsutani Chemical Industry Co., Ltd. Examples of dextrin made from corn starch, potato starch and sweet potato starch include Sandec #30 (DE2-5) manufactured by Sanwa Starch Co., Ltd. One type of dextrin may be used alone, or two or more types may be used in combination.

Contact between rice and a dextrin solution, comprising dextrin with DE in the above range, allows the dextrin solution to attach to the surface of the rice and/or permeate inside the rice to increase the mass per grain of rice, resulting in the improvement of the yield of cooked rice food produced. Further, since dextrin with DE in the above range has an appropriate film-formability and permeability to rice, when the rice and the dextrin solution are contacted with each other, the dextrin solution attaches to the surface of the rice to form a film while the dextrin solution permeates into the rice moderately. As a result, the dextrin solution is prevented from excessively permeating inside the rice and from excessively remaining on the surface of the rice, which enables to produce a cooked rice food having the same hardness and stickiness as rice cooked by a usual method.

The method of contacting the rice and dextrin is not particularly limited as long as the effect of the present invention is attained, and examples thereof include immersing the rice in the dextrin solution, adding the dextrin solution to the rice and mixing. The amount of the dextrin solution to be contacted with the rice is not particularly limited as long as the effect of the present invention is attained, and is preferably 1 to 19% by mass based on the total mass of the rice at the time of contact with the dextrin solution (during or after the heating step), more preferably 2 to 17% by mass, and even more preferably 2.5 to 15% by mass. The amount of dextrin comprised in the dextrin solution to be contacted with the rice is preferably 0.2 to 2.6% by mass based on the total mass of the raw material rice, more preferably 0.26 to 2.1% by mass, and even more preferably 0.53 to 1.58% by mass.

The concentration of dextrin in the dextrin solution is not particularly limited as long as the effect of the present invention is attained, and can be appropriately set depending on the amount of the dextrin solution to be contacted with the rice and the amount of dextrin comprised in the dextrin solution to be contacted with the rice. The concentration of dextrin in the dextrin solution is preferably 1.5 to 18% by mass, more preferably 2 to 15% by mass, even more preferably 2 to 14% by mass, and most preferably 2.5 to 12.5% by mass.

The contact between the rice and the dextrin solution is made at least during or after the heating step described above, and preferably after the heating step. Specifically, timing during the heating step includes, for example, immediately before the end of the heating step, preferably 15 minutes or less before the end of the heating step, more preferably 10 minutes or less before the end of the heating step, and even more preferably 5 minutes or less before the end of the heating step. Timing after the heating step is preferably 1 hour or less after the completion of the heating step, more preferably 10 minutes or less after the completion of the heating step, and even more preferably 5 minutes or less after the completion of the heating step.

The temperature of the rice at the time of contact between the rice and the dextrin solution is not particularly limited as long as the effect of the present invention is attained, and is preferably 30 to 100° C., more preferably 50 to 100° C., and even more preferably 70 to 100° C.

The water content of rice after the dextrin solution contacting step is not particularly limited as long as the effect of the present invention is attained, and may be appropriately set depending on the variety of raw material rice, the desired type of cooked rice food, and the like.

The production method of the present invention may further include other steps, such as processing step, refrigeration step, and freezing step in addition to the above-mentioned heating step and dextrin solution contacting step.

The processing step is a step of adding seasonings and ingredients and/or further cooking the rice during production of cooked rice food. The seasonings and ingredients to be added and the cooking method can be appropriately set depending on the desired cooked rice food.

Further, a cooked rice food produced by the production method of the present invention can be provided in the form of a room temperature food, and can also be provided in the form of a refrigerated food, a frozen food, or the like through a refrigerating step and a freezing step. It can be provided also in the form of instant food, retort food and the like. Specific examples of providing cooked rice foods produced by the production method of the present invention include the following types of food in the form of normal temperature food, refrigerated food or frozen food: white rice, fried rice, pilaf, dry curry, chicken rice, butter rice, bibimbap, jambalaya, nasi goreng, takikomi gohan, sushi rice, chirashi-zushi, rice gruel, porridge, ochazuke, rice ball, and rice burger. Among these, particularly preferred are fried rice, pilaf, dry curry, chicken rice, butter rice, bibimbap, jambalaya, nasi goreng and rice ball in the form of frozen food.

In the refrigerating step, well-known methods can be used as a method for refrigerating the cooked rice food produced by the production method of the present invention, and among them, an appropriate method can be selected depending on the type of the cooked rice food and the like. For example, cooked rice food can be obtained in a refrigerated food form by storing in a refrigerator at 1 to 10° C.

In the freezing step, well-known methods can be used as a method for freezing the cooked rice food produced by the production method of the present invention, and among them, an appropriate method can be selected depending on the type of the cooked rice food and the like. Preferably, the cooked rice food can be obtained in a frozen food form by rapidly freezing at −30° C. or lower. Further, the obtained frozen food is stored at −15° C. or lower, preferably −18° C. or lower.

The cooked rice foods in the form of refrigerated or frozen foods can be eaten through various heat treatments using a microwave oven, a frying pan, a hot water bath, and the like.

### EXAMPLES

Hereinafter, the present invention will be specifically described based on Examples, but the present invention is not limited to these Examples. In the present Examples, unless otherwise specified, dextrin was Pinedex #100 (DE2-5) manufactured by Matsutani Chemical Industry Co., Ltd., rice as a raw material was Kirara397, and the rice cooker was IH rice cooker NP-VN18 manufactured by Zojirushi Corporation.

### Example 1

### Verification 1 of Effect of Adding Dextrin Solution

### (1) Preparation of Cooked Rice Food

The effect of adding a dextrin solution was verified using a cooked rice food (cooked rice) in each test group prepared in accordance with the following method.

Specifically, raw material rice was cooked using a rice cooker by a ratio of added water of 1.2 times (ratio of mass of water to raw material rice) during cooking (heating step), and to the rice immediately after the completion of cooking, a 5% by mass aqueous dextrin solution was added so that an amount of dextrin became 1.05% by mass based on the total mass of the rice and contacted with the rice to obtain the cooked rice food (white rice) of Test Group 1. The cooked rice food (white rice cooked by a usual method) in Test Group 2 was obtained by the same procedure as in Test Group 1 except that no aqueous dextrin solution was added. Further, the cooked rice food (white rice) in Test Group 3 was obtained by the same procedure as in Test Group 1 except that no aqueous dextrin solution was added and the ratio of added water during rice cooking was 1.4 times.

### (2) Evaluation of Cooked Rice Food

The cooked rice foods in Test Groups 1 to 3 prepared in above (1) were each spread on a vat in a thin and flat form and rapidly frozen at about −35° C. Then, after freeze storage at −18° C., about 300 g of the rice was placed on a plate, wrapped and heat cooked in a microwave oven (600 W for 4 minutes), and then the cooked rice food in each test group was subjected to a sensory evaluation test. In the sensory evaluation test, evaluation was performed on hardness, stickiness, and overall quality of cooked rice food in each test group, in 0.5-point increments based on the following criteria, by 6 panel members who were well trained and skilled in food evaluation.

Hardness of Cooked Rice Food

5 points: Hard

4 points: Slightly hard

3 points: Moderately hard

2 points: Slightly soft

1 point: Soft

### Stickiness of Cooked Rice Food

5 points: Not sticky

4 points: Slightly sticky

3 points: Rather sticky

2 points: Sticky

1 point: Very sticky

### Comprehensive Evaluation of Cooked Rice Food

5 points: Very preferred quality as cooked rice food

4 points: Preferred quality as cooked rice food

3 points: Preferred quality to be accepted as cooked rice food

2 points: Slightly poor quality as cooked rice food

1 point: Poor quality as cooked rice food

The results of the sensory evaluation test are shown in Table 1 below. The evaluation score was the average of the evaluation scores of the 6 panel members.

TABLE 1
Verification 1 of effect of adding dextrin solution

| | | | Amount of | | | | |
|---|---|---|---|---|---|---|---|
| | | | added | | | | |
| | | | dextrin | | | | |
| | Addition | Ratio of | based on rice | | Sensory Evaluation | | |
| | of dextrin | added | amount | | | | Total |
| | solution | water | (mass %) | Yield | Hardness | Stickiness | Evaluation |
| Test Group 1 | Yes | 1.2 times | 1.05 | 228% | 3.0 | 4.0 | 4.0 |
| Test Group 2 | No | 1.2 times | 0 | 211% | 3.0 | 5.0 | 5.0 |
| Test Group 3 | No | 1.4 times | 0 | 228% | 2.0 | 2.0 | 2.0 |

From the results shown in Table 1, the cooked rice food in Test Group 1, with the addition of the aqueous dextrin solution, almost maintained the quality as compared with the cooked rice food cooked by a usual method (Test Group 2) and had a preferred quality as a cooked rice food. In addition, the cooked rice food in Test Group 1 had a higher yield than the cooked rice food in Test Group 2, and had the same level of yield as the cooked rice food in Test Group 3 with higher ratio of added water (the quality of cooked rice food deteriorated due to increased ratio of added water).

### Example 2

### Verification 2 of Effect of Adding Dextrin Solution

### (1) Preparation of Cooked Rice Food

The effect of adding a dextrin solution was verified using a cooked rice food (white rice) in each test group prepared in accordance with the following method.

Specifically, the cooked rice foods in Test Groups A-D were each obtained by the same procedure as in Test Group 1 above except that aqueous solutions of the following ingredients were added to the rice instead of the aqueous dextrin solution: processed starch (pregelatinized ether, Farinex TG600, manufactured by Matsutani Chemical Industry Co., Ltd.), pregelatinized non-glutinous rice starch (My Alpha K, manufactured by Joetsu Starch Co., Ltd.), soybean polysaccharide (Soya Five-SDN manufactured by Fuji Oil Co., Ltd.) and oil and fat emulsifier (Rice Good RM-100 manufactured by Riken Vitamin Co., Ltd.). Further, the cooked rice food of Test Group E was obtained by the same procedure as in Test Group 1 above except that an aqueous solution of trehalose (manufactured by Hayashibara Co., Ltd.) was added to the rice instead of the aqueous dextrin solution, at a ratio of added water of 1.3 times and with the trehalose concentration of 33.3% by mass in the aqueous solution. In addition, the concentration of each compound based on the total mass of the rice was 1.05% by mass for processed starch, pregelatinized non-glutinous rice starch, soybean polysaccharide and oil and fat emulsifier, and 1% by mass for trehalose.

### (2) Evaluation of Cooked Rice Food

The cooked rice foods in Test Groups A to E prepared in above (1) and the cooked rice food in Test Group 1 described above were each subjected to a sensory evaluation test based on the same procedure and criteria as in Example 1 by 6 panel members who were well trained and skilled in food evaluation. The results of the sensory evaluation test are shown in Table 2 below. The evaluation score was the average of the evaluation scores of the 6 panel members.

TABLE 2
Verification 2 of effect of adding dextrin solution

| | | | Amount of | | | | |
|---|---|---|---|---|---|---|---|
| | | | added | | | | |
| | | | compound | | | | |
| | Added | Ratio of | based on | | Sensory Evaluation | | |
| | aqueous | added | rice amount | | | | Total |
| | solution | water | (mass %) | Yield | Hardness | Stickiness | Evaluation |
| Test | Dextrin | 1.2 | 1.05 | 228% | 3.0 | 4.0 | 4.0 |
| Group 1 | | times | | | | | |
| Test | Processed | 1.2 | 1.05 | 228% | 2.3 | 1.7 | 1.8 |
| Group A | starch | times | | | | | |
| Test | Pregelatinized | 1.2 | 1.05 | 228% | 2.0 | 1.8 | 1.8 |
| Group B | non-glutinous | times | | | | | |
| | rice starch | | | | | | |
| Test | Soybean | 1.2 | 1.05 | 228% | 2.5 | 2.2 | 2.2 |
| Group C | polysaccharide | times | | | | | |
| Test | Oil and fat | 1.2 | 1.05 | 228% | 2.2 | 2.3 | 2.0 |
| Group D | emulsifier | times | | | | | |
| Test | Trehalose | 1.3 | 1 | 239% | 2.0 | 2.3 | 2.2 |
| Group E | solution | times | | | | | |

From the results shown in Table 2, the cooked rice food in Test Group 1, with the addition of the aqueous dextrin solution, had an improved yield compared with the cooked rice food cooked by a usual method (Test Group 2) and a preferred quality as a cooked rice food. On the other hand, the cooked rice foods in Test Groups A to E, to which aqueous solutions of the following ingredients were added instead of the aqueous dextrin solution: processed starch, pregelatinized non-glutinous rice starch, soybean polysaccharide, oil and fat emulsifier, and trehalose, did not have a preferred quality to be accepted as a cooked rice food, although they had an improved yield compared with the cooked rice food in Test Group 2.

### Example 3

### Examination of Timing of Adding Dextrin Solution

### (1) Preparation of Cooked Rice Food

The timing of adding the dextrin solution was examined using the cooked rice food (white rice) in each test group prepared in accordance with the following method.

Specifically, the cooked rice foods in Test Groups 4 and 6 were each obtained by the same procedure as in Test Group 1 described above, except that the timing of adding the aqueous dextrin solution was changed from immediately after the completion of rice cooking to during rice cooking, and before the start of rice cooking, respectively.

### (2) Evaluation of Cooked Rice Food

The cooked rice foods in Test Groups 4 and 6 prepared in above (1) and the cooked rice food in Test Group 1 described above were each subjected to a sensory evaluation test based on the same procedure and criteria as in Example 1 by 6 panel members who were well trained and skilled in food evaluation. The results of the sensory evaluation test are shown in Table 3 below. The evaluation score was the average of the evaluation scores of the 6 panel members.

TABLE 3
Examination of timing of
adding dextrin solution

| | | | Sensory Evaluation | | |
|---|---|---|---|---|---|
| | Addition timing | | | | Total |
| | of dextrin | | | | Eval- |
| | solution | Yield | Hardness | Stickiness | uation |
| Test Group 1 | Immediately after | 228% | 3.0 | 4.0 | 4.0 |
| | rice cooking | | | | |
| Test Group 4 | Before start of | 228% | 2.2 | 1.7 | 1.7 |
| | rice cooking | | | | |
| Test Group 6 | During | 229% | 2.7 | 3.2 | 3.0 |
| | rice cooking | | | | |

From the results shown in Table 3, the cooked rice food in Test Group 1, in which the aqueous dextrin solution was added immediately after the completion of rice cooking, had an improved yield as compared with the cooked rice food (Test Group 2) cooked by a usual method and had a preferred quality as a cooked rice food. Further, the cooked rice food of Test Group 6, in which the aqueous dextrin solution was added during cooking rice, also had an improved yield as compared with the cooked rice food of Test Group 2 and had a preferred quality to be accepted as a cooked rice food. On the other hand, the cooked rice food in Test Group 4, in which the aqueous dextrin solution was added before the start of rice cooking, did not have a preferred quality to be accepted as a cooked rice food, although they had an improved yield as compared with the cooked rice food in Test Group 2.

### Example 4

Examination of Rice Temperature when Dextrin Solution is Added

### (1) Preparation of Cooked Rice Food

The temperature of rice when the dextrin solution was added was examined using the cooked rice food (white rice) in each test group prepared in accordance with the following method.

Specifically, the cooked rice foods in Test Groups 7 and 8 were each obtained by the same procedure as in Test Group 1 described above, except that the temperature of the rice at the time of addition of the aqueous dextrin solution was changed from 90° C. (immediately after the completion of rice cooking) to 70° C. (cooled and kept warm after the completion of rice cooking) and room temperature (cooled and kept warm after the completion of rice cooking), respectively.

### (2) Evaluation of Cooked Rice Food

The cooked rice foods in Test Groups 7 and 8 prepared in above (1), and in Test Group 1 described above were each subjected to a sensory evaluation test based on the same procedure and criteria as in Example 1 by 6 panel members who were well trained and skilled in food evaluation. The results of the sensory evaluation test are shown in Table 4 below. The evaluation score was the average of the evaluation scores of the 6 panel members.

TABLE 4
Examination of rice
temperature when
dextrin solution is added

| | Rice | | Sensory | | |
|---|---|---|---|---|---|
| | temperature | | Evaluation | | |
| | when dextrin | | | | Total |
| | solution | | | | Eval- |
| | was added | Yield | Hardness | Stickiness | uation |
| Test Group 1 | 90° C. | 228% | 3.0 | 4.0 | 4.0 |
| Test Group 7 | 70° C. | 227% | 2.8 | 3.2 | 3.2 |
| Test Group 8 | 20° C. | 225% | 2.7 | 2.3 | 2.7 |

From the results shown in Table 4, the cooked rice food in Test Group 1, in which the aqueous dextrin solution was added at a rice temperature of 90° C., had an improved yield as compared with the cooked rice food (Test Group 2) cooked by a usual method and had a preferred quality as a cooked rice food. Further, the cooked rice food in Test Group 7, in which the aqueous dextrin solution was added at a rice temperature of 70° C., had an improved yield as compared with the cooked rice food of Test Group 2 and had a preferred quality to be accepted as a cooked rice food. On the other hand, the cooked rice food in Test Group 8, in which the aqueous dextrin solution was added at a rice temperature of 20° C., did not have a preferred quality to be accepted as a cooked rice food, although it had an improved yield as compared with the cooked rice food of Test Group 2.

### Example 5

### Examination of DE of Dextrin Comprised in Dextrin Solution

### (1) Preparation of Cooked Rice Food

The dextrose equivalent (DE) of dextrin comprised in the dextrin solution was examined using the cooked rice food (white rice) in each test group prepared in accordance with the following method.

Specifically, the cooked rice foods in Test Groups 9 to 12 were each obtained by the same procedure as in Test Group 1 described above, except that the dextrin comprised in the aqueous dextrin solution added to the rice was changed from Pinedex #100 to Paselli SA2 (<DE2, manufactured by Matsutani Chemical Industry Co., Ltd.), Pinedex #1 (DE7-9, manufactured by Matsutani Chemical Industry Co., Ltd.), Pinedex #2 (DE10-12, manufactured by Matsutani Chemical Industry Co., Ltd.) and Pinedex #4 (DE18-20, manufactured by Matsutani Chemical Industry Co., Ltd.), respectively.

### (2) Evaluation of Cooked Rice Food

The cooked rice foods in Test Groups 9 to 12 prepared in above (1), and in Test Group 1 described above were each subjected to a sensory evaluation test based on the same procedure and criteria as in Example 1 by 6 panel members who were well trained and skilled in food evaluation. The results of the sensory evaluation test are shown in Table 5 below. The evaluation score was the average of the evaluation scores of the 6 panel members.

TABLE 5
Examination of DE of dextrin comprised in dextrin solution

| | | | | Sensory Evaluation | | |
|---|---|---|---|---|---|---|
| | Dextrin product | DE | Yield | Hardness | Stickiness | Total Evaluation |
| Test Group 1 | Pinedex #100 | 2-5 | 228% | 3.0 | 4.0 | 4.0 |
| Test Group 9 | Paselli SA2 | <2 | 228% | 2.2 | 2.7 | 2.5 |
| Test Group 10 | Pinedex #1 | 7-9 | 228% | 3.0 | 3.5 | 3.5 |
| Test Group 11 | Pinedex #2 | 10-12 | 228% | 2.7 | 3.0 | 2.7 |
| Test Group 12 | Pinedex #4 | 18-20 | 228% | 1.7 | 1.8 | 1.8 |

From the results shown in Table 5, the cooked rice food in Test Group 1, in which the aqueous dextrin solution to be added to the rice comprised Pinedex #100 with DE2 to 5, had an improved yield as compared with the cooked rice food (Test Group 2) cooked by a usual method and had a preferred quality as a cooked rice food. Further, the cooked rice food in Test Group 10, in which the aqueous dextrin solution to be added to the rice comprised Pinedex #1 with DE7 to 9, and the cooked rice food in Test Group 11, in which the aqueous dextrin solution to be added to the rice comprise Pinedex #2 with DE10 to 12 had an improved yield as compared with the cooked rice food of Test Group 2 and had a preferred quality to be accepted as a cooked rice food. On the other hand, the cooked rice food in Test Group 9, in which the aqueous dextrin solution to be added to the rice comprised Paselli SA2 with DE less than 2, and the cooked rice food in Test Group 12, in which the aqueous dextrin solution to be added to the rice comprised Pinedex #4 with DE18 to 20, did not have a preferred quality to be accepted as a cooked rice food, although they had an improved yield as compared with the cooked rice food of Test Group 2.

### Example 6

### Examination of Concentration of Dextrin in Dextrin Solution

### (1) Preparation of Cooked Rice Food

The concentration of dextrin in the dextrin solution was examined using the cooked rice food (white rice) in each test group prepared in accordance with the following method.

Specifically, the cooked rice foods in Test Groups 13 to 18 were each obtained by the same procedure as in Test Group 1 described above, except that the concentration of dextrin in the aqueous dextrin solution added to the rice was changed from 5% by mass to 0% by mass, 1.25% by mass, 2.5% by mass, 10% by mass, 12.5% by mass and 15% by mass, respectively.

### (2) Evaluation of Cooked Rice Food

The cooked rice foods in Test Groups 13 to 18 prepared in above (1), and in Test Group 1 described above were each subjected to a sensory evaluation test based on the same procedure and criteria as in Example 1 by 6 panel members who were well trained and skilled in food evaluation. The results of the sensory evaluation test are shown in Table 6 below. The evaluation score was the average of the evaluation scores of the 6 panel members.

TABLE 6
Examination of concentration
of dextrin in dextrin solution

| | | | Sensory | | |
|---|---|---|---|---|---|
| | | | Evaluation | | |
| | dextrin | | | | Total |
| | concentration | | | | Eval- |
| | (% by mass) | Yield | Hardness | Stickiness | uation |
| Test Group 1 | 5 | 228% | 3.0 | 4.0 | 4.0 |
| Test Group 13 | 0 | 228% | 1.5 | 1.3 | 1.5 |
| Test Group 14 | 1.25 | 228% | 1.8 | 2.0 | 2.0 |
| Test Group 15 | 2.5 | 228% | 2.7 | 3.0 | 3.2 |
| Test Group 16 | 10 | 228% | 3.2 | 3.3 | 3.3 |
| Test Group 17 | 12.5 | 228% | 3.3 | 2.8 | 3.0 |
| Test Group 18 | 15 | 228% | 2.7 | 2.2 | 2.2 |

From the results shown in Table 6, the cooked rice food in Test Group 1, in which the aqueous dextrin solution to be added to the rice had a dextrin concentration of 5% by mass, had an improved yield as compared with the cooked rice food (Test Group 2) cooked by a usual method and had a preferred quality as a cooked rice food. Further, the cooked rice foods in Test Group 15, in which the aqueous dextrin solution to be added to the rice had a dextrin concentration of a 2.5% by mass, in Test Group 16 of 10% by mass, and in Test Group 17 of 12.5% by mass, had an improved yield as compared with the cooked rice food of Test Group 2 and had a preferred quality to be accepted as a cooked rice food. On the other hand, the cooked rice foods in Test Group 13, with a dextrin concentration of 0% by mass, in Test Group 14 of 1.25% by mass, and in Test Group 18 of 15% by mass, did not have a preferred quality to be accepted as a cooked rice food, although they had an improved yield as compared with the cooked rice food of Test Group 2.

### Example 7

### Examination of Form of Dextrin

### (1) Preparation of Cooked Rice Food

The form of dextrin was examined using the cooked rice food (white rice) in each test group prepared in accordance with the following method.

Specifically, the cooked rice food in Test Group 19 was obtained by the same procedure as in Test Group 1 described above, except that the aqueous dextrin solution to be added to the rice was changed to dextrin powder (Sandec #30, DE3.0) manufactured by Sanwa Starch Co., Ltd., 1% by mass of the dextrin powder was added to the rice after cooking, and the ratio of added water was changed to 1.35 times.

### (2) Evaluation of Cooked Rice Food

The cooked rice foods in Test Group 19 prepared in above (1), and in Test Group 1 described above were each subjected to a sensory evaluation test based on the same procedure and criteria as in Example 1 by 6 panel members who were well trained and skilled in food evaluation. The results of the sensory evaluation test are shown in Table 7 below. The evaluation score was the average of the evaluation scores of the 6 panel members.

TABLE 7
Examination of form of dextrin

| | | | | Sensory Evaluation | | |
|---|---|---|---|---|---|---|
| | Form of dextrin | DE of dextrin | Yield | Hardness | Stickiness | Total Evaluation |
| Test Group 1 | Aqueous solution | 2-5 | 228% | 3.0 | 4.0 | 4.0 |
| Test Group 19 | Powder | 3.0 | 225% | 2.5 | 2.5 | 2.8 |

From the results shown in Table 7, though DE in Test Group 1 and Test Group 19 were almost the same, the cooked rice food in Test Group 1, in which dextrin was added in the form of solution, had an improved yield as compared with the cooked rice food (Test Group 2) cooked by a usual method and had a preferred quality as a cooked rice food; on the other hand, the cooked rice food in Test Group 19, in which dextrin was added in the form of powder, did not have a preferred quality to be accepted as a cooked rice food, although it had an improved yield as compared with the cooked rice food of Test Group 2.

### Example 8

### Examination of Amount of Added Dextrin Solution

### (1) Preparation of Cooked Rice Food

The amount of added dextrin solution was examined using the cooked rice food (white rice) in each test group prepared in accordance with the following method.

Specifically, the cooked rice foods in Test Groups 21 to 23 and 39 were each obtained by the same procedure as in Test Group 1 described above, except that an aqueous dextrin solution was added to the rice at an amount of 2.5% by mass based on the total mass of the rice after the heating step (dextrin at an amount of 0.26% by mass based on the total mass of the rice before the heating step), 5% by mass (dextrin at an amount of 0.53% by mass based on the total mass of the rice before the heating step), 15% by mass (dextrin at an amount of 1.58% by mass based on the total mass of the rice before the heating step) and 20% by mass (dextrin at an amount of 2.1% by mass based on the total mass of the rice before the heating step), respectively. In addition, the cooked rice food in Test Group 20 was obtained by the same procedure as the test group 1 described above except that the aqueous dextrin solution was not added to the rice. The cooked rice food in Test Group 20 is the same as that in Test Group 2.

### (2) Evaluation of Cooked Rice Food

The cooked rice foods in Test Groups 20 to 23 and 39 prepared in above (1), and in Test Group 1 described above were each subjected to a sensory evaluation test based on the same procedure and criteria as in Example 1 by 6 panel members who were well trained and skilled in food evaluation. The results of the sensory evaluation test are shown in Table 8 below. The evaluation score was the average of the evaluation scores of the 6 panel members.

TABLE 8
Examination of amount of added dextrin solution

| | Amount of added | amount of | | | | |
|---|---|---|---|---|---|---|
| | dextrin solution | added dextrin | | Sensory Evaluation | | |
| | based on rice | based on rice | | | | Total |
| | amount (mass %) | amount (mass %) | Yield | Hardness | Stickiness | Evaluation |
| Test Group 1 | 10 | 1.05 | 228% | 3.0 | 4.0 | 4.0 |
| Test Group 20 | 0 | 0 | 211% | 3.0 | 5.0 | 5.0 |
| Test Group 21 | 2.5 | 0.26 | 215% | 3.5 | 4.5 | 4.2 |
| Test Group 22 | 5 | 0.53 | 219% | 3.5 | 4.2 | 4.2 |
| Test Group 23 | 15 | 1.58 | 236% | 2.7 | 3.3 | 3.0 |
| Test Group 39 | 20 | 2.1 | 244% | 2.1 | 1.8 | 1.9 |

From the results shown in Table 8, the cooked rice food in Test Group 1, in which the amount of added aqueous dextrin solution was 10% by mass based on the total mass of the rice after the heating step, had an improved yield as compared with the cooked rice foods (Test Groups 2 and 20) cooked by a usual method and had a preferred quality as a cooked rice food. Further, the cooked rice foods in Test Group 21, in which the amount of added aqueous dextrin solution was 2.5% by mass based on the total mass of the rice after the heating step, in Test Group 22 of 5% by mass, and in Test Group 23 of 15% by mass, also had an improved yield as compared with the cooked rice foods of Test Group 2 and 20, and had a preferred quality to be accepted as a cooked rice food. On the other hand, the cooked rice food in Test Group 39, in which the amount of added aqueous dextrin solution was 20% by mass based on the total mass of the rice after the heating step, did not have a preferred quality to be accepted as a cooked rice food, although it had an improved yield as compared with the cooked rice food of Test Groups 2 and 20.

### Example 9

### Examination 1 of Effects of Variety of Rice and Addition of Dextrin Solution

### (1) Preparation of Cooked Rice Food

The effects of variety of rice and addition of dextrin solution were examined using the cooked rice food (white rice) in each test group prepared in accordance with the following method.

Specifically, the cooked rice foods in Test Groups 24 and 25 were each obtained by the same procedure as in Test Group 3 described above, except that the variety of rice was changed from Kirara397 to Koshihikari and Indica rice, respectively, and the ratio of added water was changed. Further, the cooked rice foods in Test Group 27 and 28 were each obtained by the same procedure as in Test Group 1 described above, except that the variety of rice was changed from Kirara397 to Koshihikari and Indica rice, respectively, and the ratio of added water was changed.

### (2) Evaluation of Cooked Rice Food

The cooked rice foods in Test Groups 24, 25, 27 and 28 prepared in above (1), and in Test Groups 1 and 3 described above were each subjected to a sensory evaluation test based on the same procedure and criteria as in Example 1 by 6 panel members who were well trained and skilled in food evaluation. The results of the sensory evaluation test are shown in Table 9 below. The evaluation score was the average of the evaluation scores of the 6 panel members.

TABLE 9
Examination of effects of variety of rice and addition of dextrin solution

| | | | | | Sensory Evaluation | | |
|---|---|---|---|---|---|---|---|
| | | Addition of | Ratio of | | | | Total |
| | Rice varieties | dextrin solution | added water | Yield | Hardness | Stickiness | Evaluation |
| Test Group 3 | Kirara397 | No | 1.4 times | 228% | 2.0 | 2.0 | 2.0 |
| Test Group 1 | Kirara397 | Yes | 1.2 times | 228% | 3.0 | 4.0 | 4.0 |
| Test Group 24 | Koshihikari | No | 1.4 times | 229% | 1.8 | 2.0 | 2.0 |
| Test Group 27 | Koshihikari | Yes | 1.2 times | 230% | 2.5 | 2.8 | 2.8 |
| Test Group 25 | Indica | No | 1.4 times | 231% | 1.5 | 2.3 | 1.7 |
| Test Group 28 | Indica | Yes | 1.2 times | 231% | 2.0 | 2.7 | 2.7 |

From the results shown in Table 9, the cooked rice food using Kirara397 (Test Group 1), with the addition of an aqueous dextrin solution, had an improved yield as compared with the cooked rice food (Test Group 2) cooked by a usual method and as high a yield as the cooked rice food in Test Group 3 with a high ratio of added water (the increased ratio of added water deteriorated the quality as a cooked rice food), and had a preferred quality as a cooked rice food. Further, both of the cooked rice foods of Koshihikari (Test Group 27) and indica rice (Test Group 28), had an improved yield as compared with the cooked rice food cooked by a usual method (Test Group 2) and had a preferred quality to be accepted as a cooked rice food. On the other hand, none of the cooked rice foods, without the addition of the aqueous dextrin solution, of Kirara397 (Test Group 3), Koshihikari (Test Group 24) and indica rice (Test Group 25) had a preferred quality to be accepted as a cooked rice food, although they had an improved yield as compared with the cooked rice food of Test Group 2.

### Example 10

### Examination 2 of Effects of Variety of Rice and Addition of Dextrin Solution

### (1) Preparation of Cooked Rice Food

The effects of the variety of rice and the addition of dextrin solution were examined using the cooked rice food (white rice) in each test group prepared in accordance with the following method.

Specifically, the cooked rice food in Test Group 26 was obtained by the same procedure as in Test Group 3 described above, except that the variety of rice was changed to glutinous rice and the ratio of added water was changed. Further, the cooked rice food in Test Group 29 was obtained by the same procedure as in Test Group 1 described above, except that the variety of rice was changed to glutinous rice and the ratio of added water was changed.

### (2) Evaluation of Cooked Rice Food

The cooked rice foods in Test Group 26 and 29 prepared in above (1) were each subjected to a sensory evaluation test based on the same procedure and criteria as in Example 1 by 6 panel members who were well trained and skilled in food evaluation. The results of the sensory evaluation test are shown in Table 10 below. The evaluation score was the average of the evaluation scores of the 6 panel members.

TABLE 10
Examination of effects of variety of rice and addition of dextrin solution

| | | | | | Sensory Evaluation | | |
|---|---|---|---|---|---|---|---|
| | | Addition of | Ratio of | | | | Total |
| | Rice varieties | dextrin solution | added water | Yield | Hardness | Stickiness | Evaluation |
| Test Group | Glutinous | No | 1.2 times | 210% | 1.3 | 1.2 | 1.5 |
| 26 | rice | | | | | | |
| Test Group | Glutinous | Yes | 1.0 times | 211% | 1.7 | 2.0 | 2.2 |
| 29 | rice | | | | | | |

From the results shown in Table 10, the cooked rice food using glutinous rice with the addition of the aqueous dextrin solution (Test Group 29) also had an improved yield as compared with the cooked rice food without the addition of dextrin (test group 26), and had a higher quality.

### Example 11

### Examination of Storage Conditions

### (1) Preparation of Cooked Rice Food

The storage conditions of cooked rice food were examined using the cooked rice food (white rice) in each test group prepared according to the following method.

Specifically, as described in Example 1, the cooked rice food in Test Group 1 described above was frozen and stored, then heat cooked and subjected to a sensory evaluation test. Further, the cooked rice food in Test Group 1 described above was stored at room temperature (20° C.) without freezing and then subjected as the cooked rice food in Test Group 30 to a sensory evaluation test without heat cooking.

### (2) Evaluation of Cooked Rice Food

The cooked rice foods in Test Groups 30 and 1 were each subjected to a sensory evaluation test based on the same procedure and criteria as in Example 1 by 6 panel members who were well trained and skilled in food evaluation. The results of the sensory evaluation test are shown in Table 11 below. The evaluation score was the average of the evaluation scores of the 6 panel members.

TABLE 11
Examination of
storage conditions

| | | | Sensory | | |
|---|---|---|---|---|---|
| | | | Evaluation | | |
| | Storage | | | | Total |
| | condition | Yield | Hardness | Stickiness | Evaluation |
| Test Group 1 | Frozen | 228% | 3.0 | 4.0 | 4.0 |
| Test Group 30 | Room | 228% | 3.2 | 4.1 | 4.2 |
| | temperature | | | | |

From the results shown in Table 11, both of the cooked rice foods in Test Group 1 stored frozen and in Test Group 30 stored at room temperature had an improved yield as compared with the cooked rice food cooked by a usual method (Test Group 2), and had a substantially maintained quality and a preferred quality as a cooked rice food.

### Example 12

### Examination of Effect of Adding Dextrin Solution on Various Cooked Rice Foods

### (1) Preparation of Cooked Rice Food

The effect of adding the dextrin solution on various cooked rice foods was examined using the cooked rice food in each test group prepared in accordance with the following method.

Specifically, the cooked rice food in Test Group 31 (fried rice) was obtained by adding ingredients and seasonings for fried rice to the white rice in Test Group 3 and subjecting them to frying treatment. Further, the cooked rice food in Test Group 32 (fried rice) was obtained by adding ingredients and seasonings for fried rice to the white rice in Test Group 1 and subjecting them to frying treatment. Further, the cooked rice food in Test Group 33 (pilaf) was obtained by adding ingredients and seasonings for pilaf to the white rice in Test Group 3 and subjecting them to frying treatment. Further, the cooked rice food in Test Group 34 (pilaf) was obtained by adding ingredients and seasonings for pilaf to the white rice in Test Group 1 and subjecting them to frying treatment.

### (2) Evaluation of Cooked Rice Food

The cooked rice foods in Test Groups 31 to 34 prepared in above (1), and in Test Groups 1 and 3 described above were each subjected to a sensory evaluation test based on the same procedure and criteria as in Example 1 by 6 panel members who were well trained and skilled in food evaluation. The results of the sensory evaluation test are shown in Table 12 below. The evaluation score was the average of the evaluation scores of the 6 panel members.

TABLE 12
Examination of effect of adding dextrin solution in various cooked rice foods

| | Cooked rice | Addition of aqueous | | Sensory Evaluation | | |
|---|---|---|---|---|---|---|
| | food | dextrin solution | Yield | Hardness | Stickiness | Total Evaluation |
| Test Group 3 | White rice | No | 228% | 2.0 | 2.0 | 2.0 |
| Test Group 1 | White rice | Yes | 228% | 3.0 | 4.0 | 4.0 |
| Test Group 31 | Fried rice | No | — | 2.2 | 2.7 | 2.5 |
| Test Group 32 | Fried rice | Yes | — | 3.2 | 4.2 | 4.0 |
| Test Group 33 | Pilaf | No | — | 2.0 | 2.5 | 2.3 |
| Test Group 34 | Pilaf | Yes | — | 3.0 | 3.5 | 3.3 |

From the results shown in Table 12, in the case where the dextrin solution was added, all of the cooked rice foods of white rice (Test Group 1), fried rice (Test Group 32) and pilaf (Test Group 34) had a substantially maintained quality as compared with the cooked rice food cooked by a usual method (test group 2), and a preferred quality to be accepted as a cooked rice food. On the other hand, in the case where the dextrin solution was not added, all of the cooked rice foods of white rice (Test Group 3), fried rice (Test Group 31) and pilaf (Test Group 33) had a deteriorated quality as compared with the cooked rice food in Test Group 2 and did not have a preferred quality to be accepted as a cooked rice food. In addition, from the results of Table 1, since it was observed that the yield of white rice in Test Group 1 was improved as compared with that of the cooked rice food in Test Group 2, the yields of the fried rice (Test Group 32) and pilaf (Test Group 34), both obtained using the white rice in Test Group 1, were presumably improved as compared with those of the fried rice and pilaf prepared by using the cooked rice food in Test Group 2.

### INDUSTRIAL APPLICABILITY

According to the present invention, there can be produced with a high yield a cooked rice food having the same quality as rice cooked by a usual method, specifically, the same hardness and stickiness.

1. A method for producing a cooked rice food comprising the following steps:
(a) a heating step of boiling or steaming raw material rice, and
(b) a dextrin solution contacting step of contacting the rice with a dextrin solution at least during or after the heating step,
wherein the dextrin solution comprises dextrin at a dextrose equivalent of 2 to 15.

2. The production method according to claim 1, wherein the rice is contacted with the dextrin solution in the step (b) so that the dextrin solution comprises 0.2 to 2.6% by mass of dextrin based on the total mass of the raw material rice.

3. The production method according to claim 1, wherein the dextrin solution in an amount of 1 to 19% by mass based on the total mass of the rice during or after the heating step is contacted with the rice in the step (b).

4. The production method according to claim 1, wherein the dextrin solution is an aqueous dextrin solution, and the aqueous dextrin solution has a dextrin concentration of 2 to 14% by mass.

5. The production method according to claim 1, wherein the dextrin solution is contacted with the rice after the heating step in the step (b).

6. The production method according to claim 1, wherein the rice in the step (b) has a temperature of 30 to 100° C.

7. The production method according to claim 1, further comprising a freezing step of freezing a cooked rice food obtained.

8. A method for improving a yield of a cooked rice food comprising the following steps:
(a) a heating step of boiling or steaming raw material rice, and
(b) a dextrin solution contacting step of contacting the rice with a dextrin solution at least during or after the heating step,
wherein the dextrin solution comprises dextrin at a dextrose equivalent of 2 to 15.

9. A cooked rice food comprising non-glutinous rice and dextrin, wherein
at least a part of the surface of the rice is coated with the dextrin,
the dextrin comprises dextrin with a dextrose equivalent of 2 to 15, and
a yield is 226 to 240%.
